(19) United States
(12) Patent Application Publication
(10) Pub. No.: US 2007/0005839 A1
(43) Pub. Date: Jan. 4, 2007

(54) Port expander device and method

(76) Inventors: Richard B. Foehringer, El Dorado Hills, CA (US); Chen Gu, Sacramento, CA (US); Jason E. Snodgress, Cameron Park, CA (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/173,217

(22) Filed: Jun. 30, 2005

(51) Int. Cl. G06F 13/38

(52) U.S. Cl. 710/62

(57) ABSTRACT

A device including a first circuit operable to perform a first function, and a second circuit operable to perform a second function. The second circuit includes a male port connector, a port replicator chip, and a female port connector. In one embodiment, the first circuit includes one or more semiconductor devices adapted to store information. In another embodiment, the first circuit includes one or more semiconductor devices adapted to print information. In still another embodiment, the first circuit includes one or more semiconductor devices adapted to input information, such as a keyboard, a game pad, or a joy stick. The male port connector is adapted to connect to a port on a host computer. The female port connector is adapted to receive another male port connector.

### TECHNICAL FIELD

This invention is related to electrical devices. More specifically the inventive subject matter is related to a device that includes a port expander and method of configuring a computer system.

### BACKGROUND INFORMATION

Universal Serial Bus (USB) ports and similar ports are becoming quite popular on personal computers, portable computers and notebook computers. Peripheral devices are devices that are communicatively coupled to a computer. Examples of peripheral devices include a printer, a mouse, an external disk drive or similar device. Currently, many of the peripheral devices include a connector for using these ports. The ports are easy to use and peripheral devices can generally be hot plugged through a USB port or similar port. In many peripheral products, the primary design for coupling the peripheral device to the computer is through a USB port or similar port. New computers generally are being provided with more and more USB or similar ports since more and more peripheral devices are using these ports to attach to a computer. With older computers and even with the newer computers, there may be instances in which all the ports on a host computer are occupied due to the popularity of these ports.

One past solution includes a separate device or external hub that has the sole purpose of connecting into a port of the host computer, and replicating the port a plurality of times. These external hubs provide a plurality of replicated ports but are generally a relatively large item, especially in mobile computing environments where a user is using a notebook or portable computer. The external hub is another bulky piece of equipment that must be carried by the user if it is actually needed. For example, if a user wants to store work on a memory stick on a computer where a mouse and a portable printer are attached to the only two ports provided by a host computer, the user has limited options. One option includes disconnecting either the mouse or the printer and connecting the memory into the now open port in the host computer. This option may also include saving the information to memory associated with the host computer. A second option is to carry an external hub, and insert the connector from the external hub into one of the ports of the host computer system and then connect the printer and the mouse to one of the ports of the external hub and the open port on the host computer. The second option requires the user to carry an external hub. A external hub is another piece of equipment or peripheral device that must be remembered, and which may be cumbersome, if carrying the peripheral devices for a mobile computing application.

### BRIEF DESCRIPTION OF THE DRAWINGS

Embodiments of the invention are pointed out with particularity in the appended claims. However, a more complete understanding of the inventive subject matter may be derived by referring to the detailed description when considered in connection with the figures, wherein like reference numbers refer to similar items throughout the figures, and:

FIG. 1 is a side view of a peripheral device that includes a replicated port engaged with a host computer, according to an example embodiment.

FIG. 2 is a schematic diagram of peripheral device that includes a replicated port, according to an example embodiment.

FIG. 3 is a perspective view of peripheral device that includes a replicated port, according to an example embodiment.

FIG. 4 is a side view of first peripheral device that includes a replicated port plugging into a first port and a second peripheral device that includes a replicated port plugging into the replicated port of the first peripheral device, according to an example embodiment.

FIG. 5 is a side view of peripheral device that includes a replicated port, plugging into a first port and a second peripheral device plugging into the replicated port of the first peripheral device, according to an example embodiment.

FIG. 6 is a top view of an assembly panel, according to an example embodiment.

FIG. 7 is a side view of a portion of the assembly panel of FIG. 6, according to an example embodiment.

FIG. 8 is a top view of an assembly panel after packaged electrical components have been solder attached, according to an example embodiment.

FIG. 9 is a side view of a portion of the assembly panel of FIG. 8 after packaged electrical components have been solder attached, according to an example embodiment.

FIG. 10 is a top view of an assembly panel after bare die are attached and wire bonded, according to an example embodiment.

FIG. 11 is a side view of a portion of an assembly panel of FIG. 10 after bare die are attached and wire bonded, according to an example embodiment.

FIG. 12 is a top view of the assembly panel after over-molding, according to an example embodiment.

FIG. 13 is a side view of a portion of the assembly panel of FIG. 12 after over-molding, according to an example embodiment.

FIG. 14 is a top view of the assembly panel during singulation, according to an example embodiment.

FIG. 15 is a top view of an individual device resulting from singulation of the assembly panel, according to an example embodiment.

FIG. 16 is a bottom view of an individual device resulting from singulation of the assembly panel, according to an example embodiment.

FIG. 17 is a cutaway side view of an individual device resulting from singulation of the assembly panel, according to an example embodiment.

FIG. 18 is a perspective view of an overmolded assembly panel that yields several types of different individual devices, according to an example embodiment.

FIG. 19 is a flow diagram of a method 1900 for forming a device, according to an example embodiment.

The description set out herein illustrates various embodiments of the invention, and such description is not intended to be construed as limiting in any manner.

### DETAILED DESCRIPTION

In the following detailed description of the preferred embodiments, reference is made to the accompanying drawings that form a part hereof, and in which are shown by way of illustration specific embodiments in which the inventive subject matter can be practiced. The embodiments illustrated are described in sufficient detail to enable those skilled in the art to practice the teachings disclosed herein. Other embodiments can be utilized and derived therefrom, such that structural and logical substitutions and changes can be made without departing from the scope of the inventive subject matter. The following detailed description, therefore, is not to be taken in a limiting sense, and the scope of various embodiments of the invention is defined only by the appended claims, along with the full range of equivalents to which such claims are entitled.

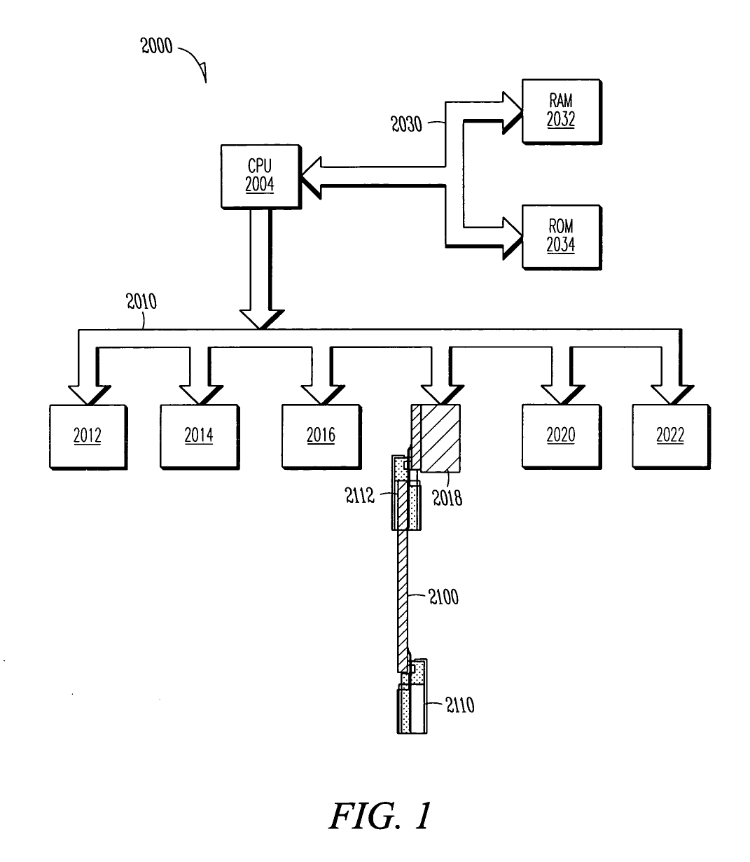

FIG. 1 is a schematic view of a host computer system 2000 that includes a side view of a peripheral port 2018 having a device 2100 that includes a replicated port 2110 engaged with the host computer 2000, according to an example embodiment. The computer system 2000 may also be called an electronic system or an information handling system, and includes a central processing unit (CPU) 2004, a random access memory (RAM) 2032, a read only memory (ROM) 2034, and a system bus 2030 for communicatively coupling the CPU 2004, the RAM 2032, and the ROM 2034. The information handling system or computer system 2000 may also include an input/output bus 2010 and several peripheral devices, such as 2012, 2014, 2016, 2020, and 2022 that may be attached to the input output bus 2010. Port 2018 is one connection point or attachment point for a peripheral device, such as peripheral device 2100. Peripheral devices may include a memory stick, a hard disc drive, a magneto optical drive, a floppy disc drive, a CD-ROM drive, a DVD drive, a monitor, a display, a keyboard, a game pad, a printer, a scanner, a fax machine, a mouse input device, an interface to a network, an MP3 player, a wireless device and any other type of peripheral device. Peripheral devices are any part of a computer device that is not an essential part of the computer. Generally, peripheral devices do not include the microprocessor and the memory. Peripheral devices many times are external to a computer and may be internal, or within the housing, of the computer.

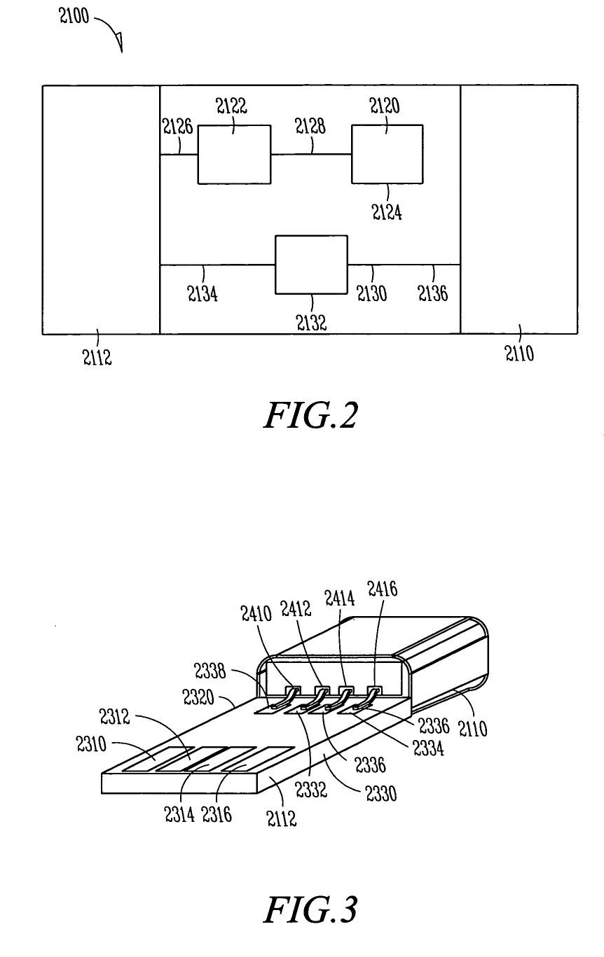

FIG. 2 is a schematic diagram of a peripheral device 2100 that includes a replicated port 2110, according to an example embodiment. Now referring both to FIGS. 1 and 2, the peripheral device 2100 will be described in more detail. The peripheral device 2100 includes a first circuit 2120 operable to perform a first function 2120 and a second circuit 2130 operable to perform a second function.

The first circuit 2120 performs a first fimction which does not include replicating the port to which the male connector 2112 is connected. The first circuit carries out functions of various input/output devices such as providing a network interface, an interface to a disk drive, or a printer or the like. In other words, the first circuit 2120 generally communicates to and from the various peripheral device, such as 2012, 2014, 2016, 2020 and 2022. The first circuit 2120, in some embodiments, may include semiconductor devices and other packaged electronic devices. For example, circuit 2120 includes a set of semiconductor devices 2122 and a set of dies or other devices 2124. The package devices 2122 and the die or other devices 2124 are attached by conductors 2126 and 2128 to the male connector 2112. In some embodiments of the invention, the first function associated with the first circuit 2120 includes storage of information. In other embodiments, the first circuit 2120 includes one or more semiconductor devices 2122 and one or more package devices 2124, which perform printing functions or which are adapted to handle print information. The first circuit 2120 can also function to receive input information such as from a keyboard, a game pad or a joystick, or a similar device. As shown in FIG. 1, the male port connector 2112 is connected to a female port connector of the port 2018 of the computer system 2000.

The peripheral device 2100 also includes a male port connecter 2112 and a female port connector 2110. The female port connector 2110 is the replicated port 2110. The second circuit includes the male port connector 2112 and a female port connector 2110. The second circuit 2130 includes a port replicator chip 2132. The port replicator chip 2132 is connected to the male connector 2112 and the female connector 2110 by conductors represented by lines 2134 and 2136. The port replicator chip 2132 is connected to all the contacts associated with the male connector 2112. The port replicator chip 2132 replicates the port at female connector 2120. The port replicator chip 2132 is connected to the female port 2110 by the conductor 2136. The port replicator chip is available as a USB HUB Controller Logic Device which is manufactured by NEC as part number uPD720112. Thus, the port replicator chip 2132 is connected to all the connection points associated with the male connector and replicates a female port into which the peripheral device 2100 is attached to. As shown in FIGS. 1 and 2, a single port 2110 is replicated from a single male connector or from the port into which the peripheral device 2100 is connected.

The device 2100, as shown in FIG. 1, may be a memory stick. In other words, the first circuit 2120 includes a set of prepackaged devices 2122 and a set of dice 2124 that include a processor and memory. Thus, the memory stick or device 2100 has two functions. The first function is to act as a solid-state memory, and the second function is to replicate the port 2018 of the computer system 2000 as port 2110. Thus, with a replicated port another peripheral device may be attached or plugged into the replicated port 2110. It should be noted that the function of the first circuit or the function of the overall device is not limited to the memory device shown in FIG. 1. The peripheral device that could include a replicated port as a second circuit 2130 includes a hard disk drive, a magneto optical drive, a floppy disk drive, a CD-ROM drive, a DVD drive, a monitor, a keyboard, a game pad, a printer, a scanner, a fax machine, a mouse input device and any other type of peripheral.

FIG. 3 is a perspective view of a peripheral device 2100 that includes a replicated port 2110, according to an example embodiment. FIG. 3 again shows a memory application. The peripheral device 2100 includes a male port connector 2112, which actually includes individual pads or connecting pads 2310, 2312, 2314 and 2316. A set of pads is also located at the end 2320 of the device to which the female and replicated port 2110 is attached. The female port 2110 includes a set of connectors 2410, 2412, 2414 and 2416. The port 2110 is connected to a main body 2330 which includes connectors or pads 2332, 2334, 2336 and 2338. The connectors 2410, 2412, 2414 and 2416 of the replicated or female port 2110 are connected to pads 2338, 2332, 2334, 2336, respectively. The main body 2330 of the device 2100 includes the first circuit 2130 and the second circuit 2120 (shown in FIG. 2).

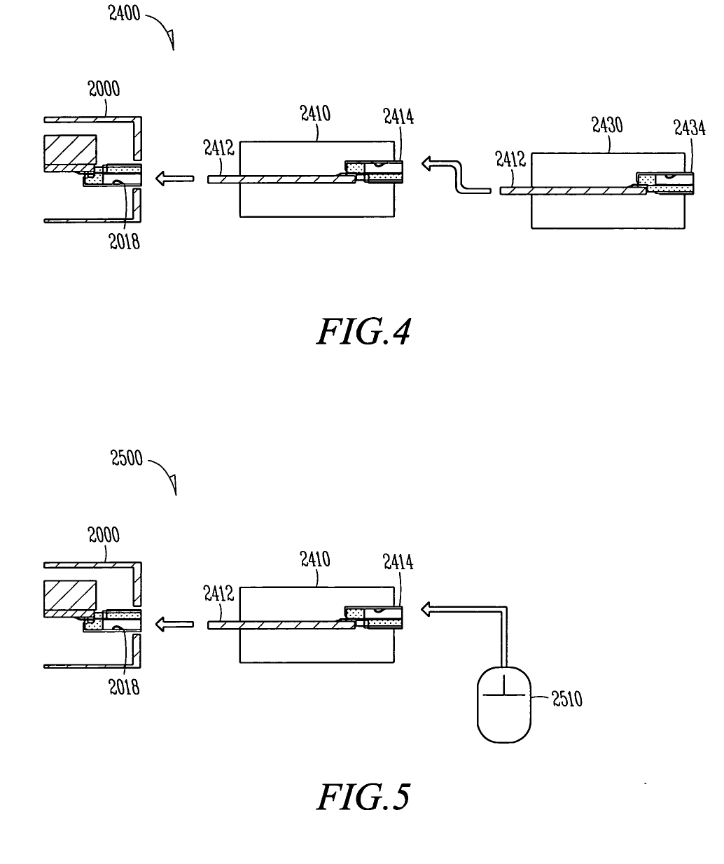

FIG. 4 is a side view of a first peripheral device 2410 and a second peripheral device 2430 that form a system 2400. The peripheral device 2410 includes a male port connector 2412 and a female port connector 2414. The device 2430 includes a male port connector 2432 and a female port connector 2434. The first device 2410 includes a first function or circuitry for a first function as well as circuitry to replicate the port 2018 as female port 2414. In other words, the first peripheral device 2410 includes two functions, one of which is a circuit to replicate the port into which the male port connector 2412 is connected. Similarly, peripheral device 2430 includes a replicator circuit for replicating the port into which the male port connector 2412 is attached at port 2434. The second peripheral device also includes a second function which differs from or is substantially different from the function of replicating the port. As shown in FIG. 4, the first peripheral device 2410 and the second peripheral device 2430 can be attached to one another through a single port 2018 on the host computer 2000. FIG. 4 shows that a number of the peripheral devices, such as the first peripheral device 2410 and the second peripheral device 2430, can be connected in daisy-chain fashion through a single port 2018 of the host computer 2000. A device at the end of the chain does not need to have a replicator circuit or a replication port.

FIG. 5 is a side view of a peripheral device 2410 that includes a replicated port 2414, that plugs into a port 2018 of a host computer 2000 and a second peripheral device 2510 that plugs into the replicated port 2414. FIG. 5 shows a system 2500 that includes the host computer 2000, the first peripheral device 2410 and the second peripheral device 2510. The first peripheral device 2410 includes a male connector portion 2412 and a female connector port 2414. The female connector port 2414 is replicated from the port 2018 into which the male port connector 2412 is connected. The first peripheral device includes a first function which is different from a second function. The second function is to replicate the port as female port 2414. The first function of circuitry or of the first peripheral device 2410 differs from replicating the port and can include storage or printing or any other function. The second peripheral device 2510, shown in FIG. 5 is an input device, such as a mouse. The mouse, or second peripheral device 2510, includes a connector which can engage either a replicated port 2414 or an original port 2018 associated with the host computer.

FIG. 5 shows an example embodiment of a configuration or system 2500 that may be especially useful for a mobile computing environment. If the host computer 2000 is a mobile computer, such as a notebook, portable computer, hand-held computer or the like, and it has a limited number of ports 2018, the user can hot plug a peripheral device 2410 that includes a replicated port 2414 into the connector associated with port 2018. Once the peripheral device 2410 is plugged into the port 2018 associated with the host computer, the replicated port 2414 becomes live and can receive a different peripheral device, such as the mouse 2510. Thus, the device 2410 includes a first function and a second function such as replicating a port, helps the user in that the user does not have to carry around additional equipment. One common application might be that device 2410 is a memory device, such as a stick memory, that includes the replicated port. When the stick memory is plugged into the port 2018, a separate drive device is identified as part of the computer configuration viewable under the “My Computer” screen. Information can be saved to the stick memory. The devices are typically small and can be held on a keychain, for exarnple. The input device 2510 can then be placed into the replicated port 2414 and can then be used to place inputs into the host computer 2000 via the replicated port 2414 and via the port 2018. Thus, the mouse or input device 2510 can be used just as though it had been originally plugged into port 2018 of the host computer 2000. When work is complete or when the desired operations are completed, the user merely unplugs device 2410 from port 2018 and unplugs the input device 2510 or mouse from the port 2414 and can pack up the system 2500 in a briefcase and move on. This port replicator on a peripheral device prevents the user from having to carry extra equipment that is especially dedicated for replicating ports.

The system 2500 includes a host computer 2000 including a port 2018 for a peripheral device, and a peripheral device 2100 engaging the port for a peripheral device. The peripheral device 2100 includes a first circuit 2120 operable to perform a first function, and a second circuit 2130 operable to perform a second function. The second circuit 2130 includes a male port connector 2110, a port replicator chip 2132, and a female port connector 2112. In one embodiment of the invention, the first circuit 2120 includes one or more semiconductor devices adapted to store information. In another embodiment of the invention, the first circuit 2120 includes one or more semiconductor devices adapted to print information. In still another embodiment, the first circuit 2120 includes one or more semiconductor devices adapted to input information. The female port connector 2112 is adapted to receive another male port connector. The system 2500 also includes a second peripheral device 2510 that includes a second peripheral device port connector. The second peripheral device port connector is engaged with the female port of the first peripheral device 2112. In one embodiment of the system 2500 the second peripheral device 2510 includes a second peripheral device male port connector, a second peripheral device port replicator chip, and a second peripheral device female port connector. The second peripheral device 2510 male port connector is engaged with the female port of the first peripheral device. The second peripheral device 2510 further comprises a third circuit operable to perform a function that differs from the port replicator of the second peripheral device. In some embodiments, the system 2500 further includes a third peripheral device. The third peripheral device includes a third peripheral device port connector. The third peripheral device port connector is engaged with the second peripheral device female port connector. The third peripheral device, in some embodiments, includes a fourth circuit operable to perform a function that differs from the port replicator of the third peripheral device. Currently a USB port is capable of receiving inputs from approximately 128 different devices. Therefore, it is possible to daisy chain as many as 127 devices together. It is contemplated that USB and other ports could be designed to receive even higher numbers of inputs, thus allowing the daisy chaining of many more devices.

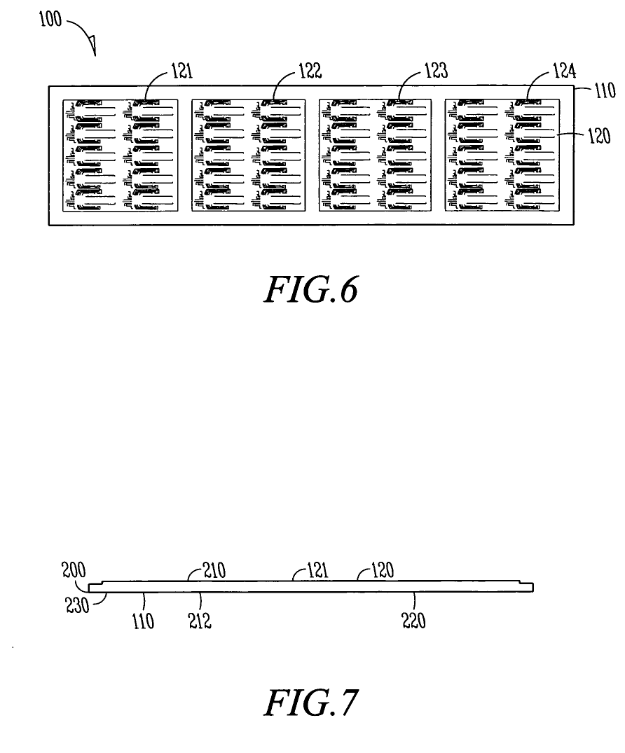

FIGS. 6 through 17 illustrate various steps in forming a device according to an example embodiment. FIG. 6 is a top view of an assembly panel 100 according to an example embodiment. The assembly panel 100 includes a substrate 110 that includes a plurality of bonding sites 120. The bonding sites 120 are for electrical bonding of components to conductors within the substrate 110. As shown in FIG. 1, the bonding sites are grouped into four different areas 121, 122, 123, and 124. Each group of bonding sites 121, 122, 123, and 124 includes circuits and conductors that will be associated with a plurality of different devices within the grouping of landing sites 121, 122, 123, and 124. In some embodiments of the invention, the groupings 121, 122, 123, and 124 of landing sites 120 can include various numbers of different devices, or can include different types of devices within a grouping 121, 122, 123, and 124. In still other embodiments each group of group 121, 122, 123, and 124 of bonding sites 120 can include a single device.

FIG. 7 is a side view of a portion of the assembly 100 shown in FIG. 6, according to an example embodiment. The portion 200 shows the substrate 110. The substrate 110 includes a first major surface 210 and a second major surface 212. The portion of the substrate 110 shows that the first major surface includes bonding sites 120 from the group of bonding sites 121. FIG. 7 also shows that the substrate includes an electrical contact 230 on the second major surface 212 of the substrate 110. Electrical conductors 220 are also positioned within the substrate 110; although not shown, the substrate could also include openings that are lined with conductive materials such as through holes for connecting conductors on the first major surface 210 to the conductors or connectors on the second major surface 212. As shown in FIGS. 6 and 7, the substrate 110 of the package assembly 100 can be in the form of a printed circuit card.

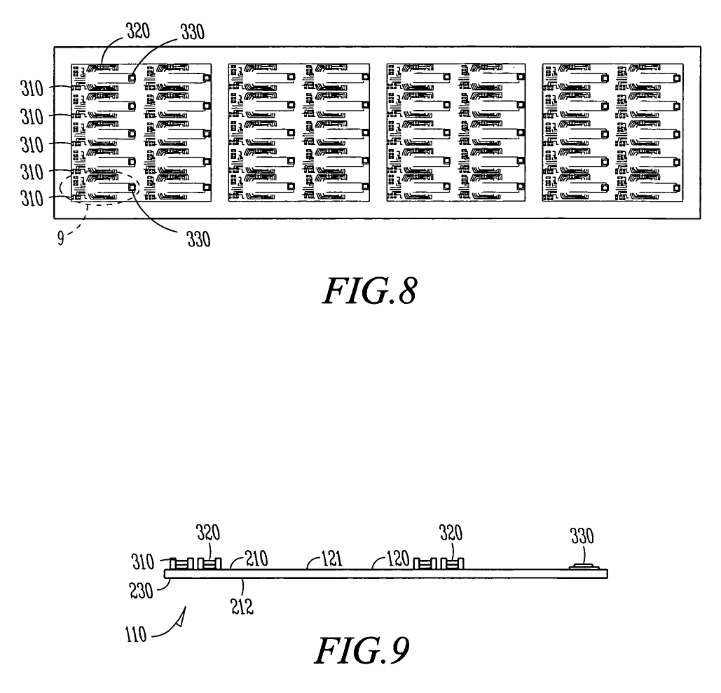

FIG. 8 is a top view of the assembly panel 100 after packaged electrical components have been solder attached, according to an example embodiment. FIG. 9 is a side view of a portion the assembly panel 100 of FIG. 8 after packaged electrical components have been solder attached, according to an example embodiment. Now looking at both FIGS. 8 and 9, the next step in the various steps for forming a device will be discussed. A pick and place machine is used to place packaged electrical components such as resistors, capacitors, and light emitting diodes (LEDs) on to bonding sites 120 associated with the first group of bonding sites on substrate 110. As shown in FIGS. 8 and 9, resistors carry a reference numeral 310, capacitors carry a reference numeral 320 and LEDs carry a reference numeral 330. As shown in FIG. 8 there are a number of devices that carry substantially identical resistors 310 and a number of devices that carry substantially identical capacitors 320 and that carry substantially identical LEDs 330. The pick and place machine places these electrical components 310, 320, 330 onto the electrical conductors or bonding sites 120 on the substrate 110. The electrical components 310, 320, 330 are then attached to the bonding sites 120 by a solder reflow process. As a result, each of the individual devices on the substrate 110 have been populated with the packaged electrical components necessary to form the individual devices.

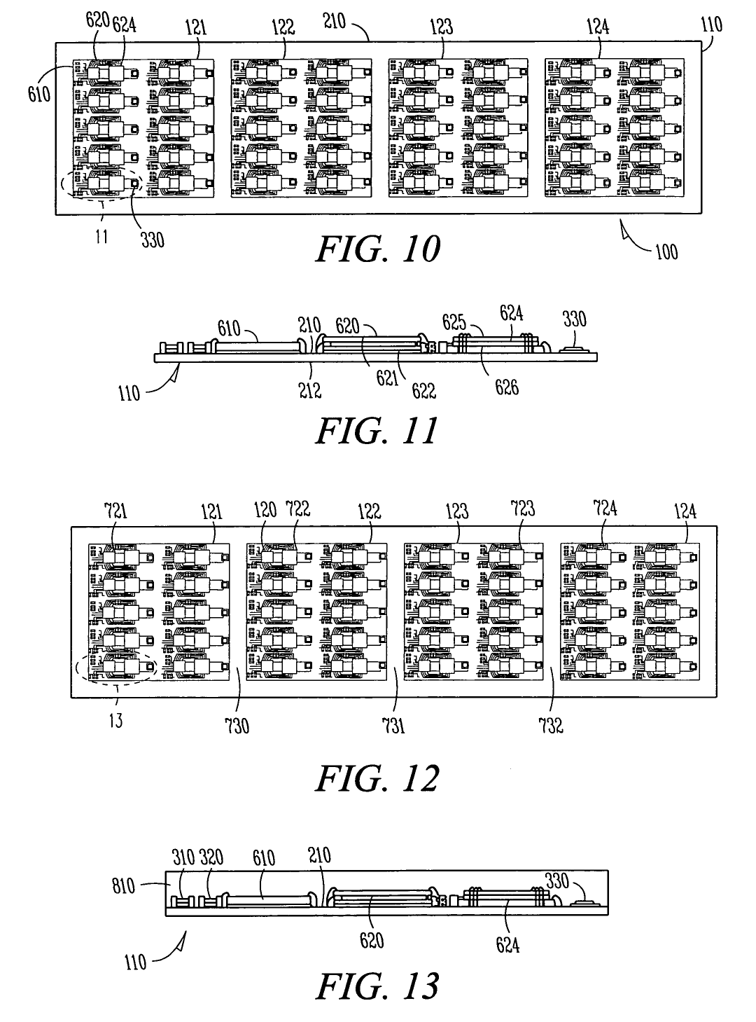

FIG. 10 is a top view of an assembly panel 500 after bare dice have been attached and wire bonded to the substrate 110. FIG. 11 is a side view of a portion of the assembly panel of FIG. 10 after the bare dice have been attached and wire bonded to the substrate 110, according to an example embodiment. Now referring to both FIGS. 10 and 11, the next step of forming devices will be discussed. Groups 121, 122, 123, 124 of bonding sites 120 are populated with a controller 610 and a first set of memory 620 and a second set of memory 624. The first set of memory 620 may include a first memory chip 621 and a second memory chip 622 stacked on to the first major surface 210 of the substrate 110. The second set of memory 624 also may include a stack of memory elements 625, 626. It should be noted that memory may also be placed on the first major surface 210 of the substrate 110 as triple stacks of memory chips or as a single memory chip, in other embodiments of the invention. The controller 610 may be a microprocessor or a dedicated microcontroller for doing specific tasks. The bare die components are attached and then wire bonded to the bonding sites 120. As shown in FIGS. 10 and 11, the substrate 110 is fully populated with packaged electrical components and bare die devices such as the controller 610 and the sets of memory 620, 624. The contacts or bonding sites 120 as well as the electrical conductors associated with the substrate form the circuit or circuits associated with particular individual devices.

FIG. 12 is a top view of an assembly panel 100 after encapsulation of the components, according to an example embodiment. FIG. 13 is a side view of a portion of the assembly panel 100 after encapsulation of the components, according to an example embodiment. Encapsulation of the components can be done by overmolding the components, glob topping, injection molding or any other encapsulation method. In the following example embodiment, overmolding is used. Now referring to both FIGS. 12 and 13, the next step in forming a number of devices will be discussed. The package assembly 100 is then placed into a mold (not shown). The mold includes clamps which clamp the edges of the package assembly 100 as well as the portions of the substrate 110 between the first group of bonding sites 121, the second group of bonding sites 122, the third group of bonding sites 123, and the fourth group of bonding sites 124. The bonding sites or groups of bonding sites form groups of individual electrical devices that have been formed on the substrate 110. More specifically, the groups of bonding sites, as now populated, form groups of individual devices 721, 722, 723, and 724. The mold includes clamps that are positioned in a street 730 and in a street 731 and in a street 732. Street 730 occurs between the group of individual devices 721 and the group of individual devices 722. Street 731 occurs between the group of individual devices 722 and the group of individual devices 723. Street 732 occurs between the group of individual devices 723 and the group of individual devices 724.

An encapsulation material, such as an overmold material, is placed into the mold. The overmold material, as seen in FIG. 13, is placed on the first major surface 210 of the substrate 110 and envelopes or encompasses or covers all of the electrical components, including the resistors 310, the capacitors 320, and the LEDs 330. An overmold material 810 may also cover the microprocessor or microcontroller 610, the first memory set 620, and the second memory set 624. Thus, as shown in FIGS. 12 and 13, the assembly panel 110 includes a plurality of devices that are in groups of devices 721, 722, 723, and 724. Each of the particular groups of devices 721, 722, 723, and 724, are covered with an overmold material 810 after an overmolding process. The overmold material 810 can include but is not limited to thermoplastics, polypropylene, polyurethane, polyethylene, thermal plastics, silicon elastomers and the like. In some embodiments, the overmold or encapsulating material is opaque. In other embodiments, clear plastic or translucent materials can also be used. The overmolding process can include injection molding or transfer molding or a similar type of molding operation.

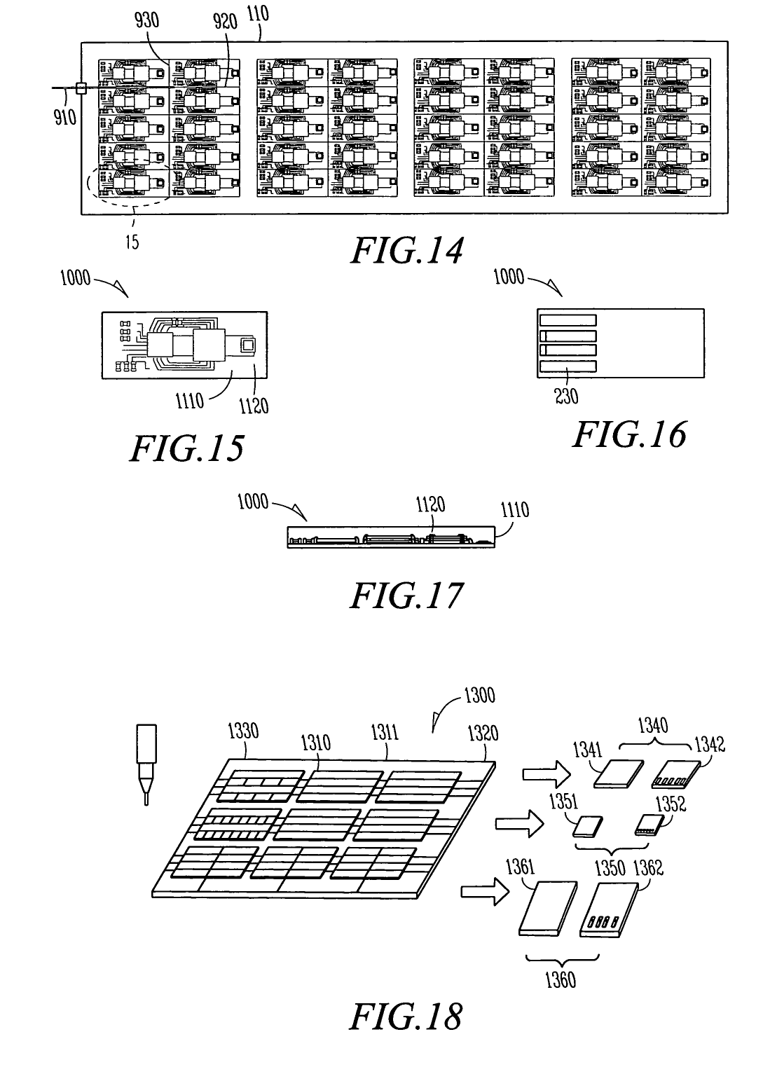

FIG. 14 is a top view of an assembly panel 100, as it is being singulated, according to an example embodiment. Singulation is merely separating the various individual devices form from one another to form a plurality of finished parts. A saw 910 is shown in FIG. 14. The saw 910 cuts the assembly panel 110 into a plurality of individual devices. The saw 910 cuts along cut lines, such as vertical cut lines 920 and horizontal cut lines 930. The end result is an individual or finished part as shown in FIG. 15.

FIGS. 15, 16, and 17 are a top view, a bottom view, and a cutaway side view of an individual device 1000 resulting from singulation of the assembly panel 110 (shown in FIGS. 6, 8, 10, 12 and 14), according to an example embodiment. Now referring to FIGS. 15, 16, and 17, the finished part or individual device 1000 will be discussed. The individual device 1000 includes various electrical components including packaged electrical components and/or dielectrical components, which are encapsulated within a substrate 1110, and the overmolded portion 1120 of the individual device 1000. The individual device 1000 also includes a bottom surface that includes connectors, such as connector 230.

FIG. 18 is a perspective view of an overmolded assembly panel 1300 that yields several types of different individual devices, according to an example embodiment. The assembly panel 1300 is formed in the same way as the assembly panel 100 (as detailed in FIG. 6 through 17). In short, the assembly panel 1300 includes a substrate 1310 that includes a series of electrical contacts or bonding sites. The substrate 1310 also includes electrical conductors within the substrate as well as electrical contacts or connectors on a second major surface of the assembly panel. The first major surface 1311 is populated with packaged electrical components which are attached to the substrate 1310 using a solder reflow process. Also attached to the first major surface 1311 of the substrate 1310 are bare die components which are wire bonded to the bonding sites. The various individual devices are grouped and then portions of the assembly panel 1300 is overmolded.

The assembly panel 1300 is then singulated, or separated along the various cut lines shown, such as horizontal cut lines 1320, and vertical cut lines 1330. The end result of singulation yields three different types of individual devices or finished parts. The finished parts or individual devices include a device 1340 which has a top surface 1341, and a bottom surface 1342, an individual device 1350 that includes a top surface 1351, and a bottom surface 1352, and an individual device 1360 that includes a top surface 1361, and a bottom surface 1362. It should be noted that an assembled panel can include any number of individual parts or individual devices.

In one embodiment of the invention, the individual devices are spaced apart from one another such that the cut lines can be moved to accommodate different form factors for the same device. Thus, by cutting along one set of cut lines, a first form factor will be obtained and by cutting along the second set of cut lines, a second form factor of an individual device can be obtained. In each device, only the form factor will differ. The circuit associated with the device will be substantially the same.

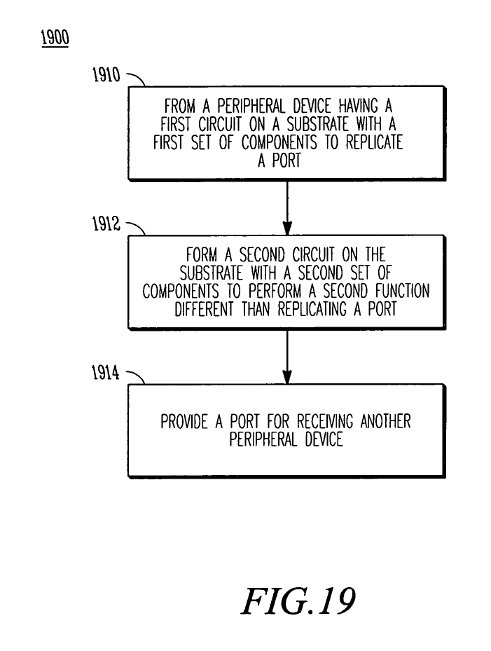

FIG. 19 is a flow diagram for a method 1900 for forming a device, according to an example embodiment. The method 1900 includes forming a peripheral device having a first circuit on a substrate with a first set of components to replicate a port 1910, and forming a second circuit on the substrate with a second set of components to perform a second function 1912 different than replicating a port. The method 1910 further comprises providing a port for receiving another peripheral device 1914. In one embodiment, the method includes overmolding the first set of components and the second set of components on the substrate with a material. One of the first major surface and a second major surface of the substrate is overmolded and the port for receiving another peripheral device is associated with the other of the first major surface and the second major surface.

Another method includes connecting a first peripheral device to a port. The first peripheral device includes a first circuit on a substrate with a first set of components to replicate a port, and a second circuit on the substrate with a second set of components to perform a second function different than replicating a port. The method includes connecting a second peripheral device to a replicated port on the first peripheral device. The second peripheral device includes a circuit on a substrate to replicate a port, and another circuit on the substrate with another set of components to perform a function other than replicating a port. In some embodiments, the method also includes connecting a third peripheral device to a replicated port on the second peripheral device. The method can also include storing information in at least one of the components of the second circuit, directing input commands to at least one of the components of the second circuit, or directing print commands in at least one of the components of the second circuit.

The foregoing description of the specific embodiments reveals the general nature of the inventive subject matter sufficiently that others can, by applying current knowledge, readily modify and/or adapt it for various applications without departing from the generic concept, and therefore such adaptations and modifications are intended to be comprehended within the meaning and range of equivalents of the disclosed embodiments.

It is to be understood that the phraseology or terminology employed herein is for the purpose of description and not of limitation. Accordingly, the embodiments of the invention are intended to embrace all such alternatives, modifications, equivalents and variations as fall within the spirit and broad scope of the appended claims.

What is claimed is:

1. A device comprising:
a first circuit operable to perform a first function; and
a second circuit operable to perform a second function, the second circuit including:
a port replicator chip; and
a female port connector.

2. The device of claim 1 wherein the second circuit includes a male port connector.

3. The device of claim 1 wherein the first circuit includes one or more semiconductor devices adapted to store information.

4. The device of claim 1 wherein the first circuit includes one or more semiconductor devices adapted to print information.

5. The device of claim 1 wherein the first circuit includes one or more semiconductor devices adapted to input information.

6. The device of claim 1 wherein the first circuit is adapted to input information using a keyboard.

7. The device of claim 1 wherein the first circuit is adapted to input information using a game pad.

8. The device of claim 1 wherein the first circuit is adapted to input information using a joy stick.

9. The device of claim 1 wherein the first circuit is adapted to input information using an MP3 player.

10. The device of claim 1 wherein the first circuit is adapted to input information using a wireless device.

10. A system comprising:
a host computer including a port for a peripheral device;
a peripheral device engaging the port for a peripheral device, the peripheral device including:
a first circuit operable to perform a first function; and
a second circuit operable to perform a second function, the second circuit including:
a male port connector;
a port replicator chip; and
a female port connector.

11. The system of claim 10 wherein the first circuit includes one or more semiconductor devices adapted to store information.

12. The system of claim 10 wherein the first circuit includes one or more semiconductor devices adapted to print information.

13. The system of claim 10 wherein the first circuit includes one or more semiconductor devices adapted to input information.

14. The system of claim 10 wherein the female port connector is adapted to receive another male port connector.

15. The system of claim 10 further comprising a second peripheral device that includes a second peripheral device port connector, wherein the second peripheral device port connector is engaged with the female port of the first peripheral device.

16. The system of claim 10 further comprising a second peripheral device that includes:
a second peripheral device male port connector;
a second peripheral device port replicator chip; and
a second peripheral device female port connector, wherein the second peripheral device male port connector is engaged with the female port of the first peripheral device.

17. The system of claim 16 wherein second peripheral device further comprises a third circuit operable to perform a function that differs from the port replicator of the second peripheral device.

18. The system of claim 16 further comprising a third peripheral device that includes a third peripheral device port connector, wherein the third peripheral device port connector is engaged with the second peripheral device female port connector.

19. The system of claim 16 wherein third peripheral device further comprises a fourth circuit operable to perform a function that differs from the port replicator of the third peripheral device.

20. A method comprising
forming a peripheral device having a first circuit on a substrate with a first set of components to replicate a port; and
forming a second circuit on the substrate with a second set of components to perform a second function different than replicating a port.

21. The method of claim 20 further comprising providing a port for receiving another peripheral device.

22. The method of claim 20 further comprising overmolding the first set of components and the second set of components on the substrate with a material.

23. The method of claim 22 wherein one of the first major surface and a second major surface of the substrate is overmolded and the port for receiving another peripheral device is associated with the other of the first major surface and the second major surface.

24. A method comprising
connecting a first peripheral device to a port, the first peripheral device including:
a first circuit on a substrate with a first set of components to replicate a port; and
a second circuit on the substrate with a second set of components to perform a second function different than replicating a port.

25. The method of claim 24 further comprising connecting a second peripheral device to a replicated port on the first peripheral device.

26. The method of claim 24 further comprising connecting a second peripheral device to a replicated port on the first peripheral device, the second peripheral device including:
a circuit on a substrate to replicate a port; and
another circuit on the substrate with another set of components to perform a function other than replicating a port.

27. The method of claim 24 further comprising connecting a third peripheral device to a replicated port on the second peripheral device.

28. The method of claim 24 further comprising storing information in at least one of the components of the second circuit.

29. The method of claim 24 further comprising directing input commands to at least one of the components of the second circuit.

30. The method of claim 24 further comprising directing print commands in at least one of the components of the second circuit.
